(19) United States
(12) Patent Application Publication
(10) Pub. No.: US 2026/0133924 A1
(43) Pub. Date: May 14, 2026

(54) STATE MACHINE FOR SERVICING REQUESTS WITHIN A SPLIT DMA CONTROLLER

(71) Applicant: TEXAS INSTRUMENTS INCORPORATED, Dallas, TX (US)

(72) Inventors: David Smith, Allen, TX (US); Vignesh Raghavendra, Bangalore (IN); Chunhua Hu, Plano, TX (US)

(21) Appl. No.: 19/255,452

(22) Filed: Jun. 30, 2025

Related U.S. Application Data
(60) Provisional application No. 63/718,768, filed on Nov. 11, 2024.

(51) Int. Cl. G06F 13/28

(52) U.S. Cl. CPC G06F 13/28; G06F 2213/28

(57) ABSTRACT

Various embodiments of the present disclosure relate to handling traffic in a split DMA controller having primary DMA channel circuits coupled to a first device, secondary DMA channel circuits coupled to second devices, a packet switch coupled to the primary and secondary DMA channel circuits, and a state machine coupled to the packet switch. In one example embodiment, a technique for pairing a primary DMA channel circuit to a secondary DMA channel circuit via the state machine is provided. The technique first includes receiving a request to transmit data via a primary DMA channel circuit to a device associated with a secondary DMA channel circuit. Next, the technique includes pairing the primary DMA channel circuit with the secondary DMA channel circuit. Finally, the technique includes instructing the primary DMA channel circuit to transmit the data to the secondary DMA channel circuit via the packet switch.

### CROSS-REFERENCE TO RELATED APPLICATION

This application is related to, and claims the benefit of priority to, U.S. Provisional Patent Application No 63/718,768, filed on Nov. 11, 2024, and entitled “AUTO PAIRING CIRCUIT FOR A CONFIGURABLE PACKET SWITCH”, which is hereby incorporated by reference in its entirety.

### TECHNICAL FIELD

Aspects of the disclosure are related to direct memory access (DMA) controllers, and in particular, to handling traffic within the context of a split DMA architecture.

### BACKGROUND

Direct memory access (DMA) controllers are devices that are commonly utilized within computing systems to offload data-transfer operations from the central processing unit (CPU) of the associated system. For example, in a system where a DMA controller is coupled to multiple memories and multiple peripherals, the CPU of the system may request the DMA controller to transfer data from a memory to a peripheral, from a peripheral to a memory, between peripherals, or between memories. More generally, the CPU of the system may request the DMA controller to transfer data from a high-latency, or low-latency source, to a high-latency, or low-latency destination. Problematically, conventional DMA controllers are often designed to manage large data transfer operations, and as a result, may tolerate higher latency and may be better suited for systems that integrate high-latency devices.

In contrast, a split DMA controller is a device that is designed to efficiently manage both large and small data transfer operations and is therefore well suited for systems that integrate both high-and low-latency devices. Typically, a split DMA controller includes a primary DMA portion that interfaces with a high-latency memory, as well as a secondary DMA portion that interfaces with various low-latency peripherals. For example, the primary DMA portion may transfer data to and from an external memory, such as flash memory, while the secondary DMA portion transfers data to and from various low-latency peripherals, such as input/output (I/O) devices, sensors, communication devices, or another peripheral of the like.

Typically, the primary DMA portion and the secondary DMA portion of a split DMA controller each include multiple DMA channels for interfacing with respective devices. For example, the primary DMA portion of a split DMA controller may include a set of high-latency DMA channels that interface with a high-latency memory. Meanwhile, the secondary DMA portion of the split DMA controller may include a set of low-latency DMA channels that interface with various low-latency peripherals.

Currently, to handle the exchange of data between the multiple high-latency DMA channels and the multiple low-latency DMA channels, the associated SoC employs a dedicated device manager that determines which of the multiple high-latency DMA channels and which of the multiple low-latency DMA channels are currently required for servicing a transfer request. Problematically, the incorporation of a dedicated device manager may increase the system cost, complexity, and power consumption, while reducing the available area. As a result, the inclusion of a dedicated device manager can be particularly detrimental in the context of low-cost, low-power SoCs, where minimizing area, cost, and energy usage is essential.

### SUMMARY

Disclosed herein is technology, including systems, methods, and devices for handling data transfer operations within the context of a split DMA controller.

In one example embodiment, a DMA controller includes a set of primary DMA channel circuits coupled to a first device, a set of secondary DMA channel circuits coupled to second devices, a packet switch coupled to both the primary and secondary DMA channel circuits, and a state machine coupled to the packet switch. In an implementation, the state machine is configured to receive a request to transmit data via a first channel circuit of the set of primary DMA channel circuits to a second device associated with a second channel circuit of the secondary DMA channels. In response to the request, the state machine is first configured to pair the first channel circuit with the second channel circuit. Once paired, the state machine is then configured to instruct the first channel circuit to transmit the data to the second channel circuit via the packet switch.

In a second example embodiment, a DMA controller includes data path circuitry including a set of primary DMA channel circuits configured to couple to a memory, and state machine circuitry coupled to the data path circuitry. In an implementation, the state machine circuitry is first configured to receive a request to transmit data via a first channel circuit of the set of primary DMA channel circuits to a device associated with a second channel circuit of a set secondary DMA channel circuits. In response to the request, the state machine circuitry is configured to pair the first channel circuit with the second channel circuit. Once paired, the state machine circuitry is then configured to instruct the data path circuitry to transmit the data from the first channel circuit to the second channel circuit. For example, the data path circuitry may transmit the data from the first channel circuit to the second channel circuit via a path of an associated packet switch.

In a third example embodiment, a non-transitory computer-readable medium having program instructions stored thereon, configured to be executable by processing circuitry is provided. In an implementation, when executed by the processing circuitry, the program instructions cause the processing circuitry to cause DMA circuitry that includes primary DMA circuitry, secondary DMA circuitry, and a packet switch coupled between the primary DMA circuitry and the secondary DMA circuitry to transfer data between a first device coupled to the primary DMA circuitry and a second device coupled to the secondary DMA circuitry by enabling a communication path of the packet switch between the primary DMA circuitry and the secondary DMA circuitry.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a method in an implementation.

FIGS. 3A and 3B illustrate sequence diagrams in various implementations.

FIG. 4 illustrates another system in an implementation.

FIG. 5 illustrates a state machine diagram in an implementation.

FIG. 6 illustrates an operational scenario in an implementation.

FIG. 7 illustrates another method in an implementation.

### DETAILED DESCRIPTION

Systems, methods, and devices are disclosed herein that provide an improved process for handling data transfer operations within the context of a split DMA controller. The disclosed technique(s) may be implemented in the context of hardware, software, firmware, or a combination thereof to provide a DMA controller that is capable of pairing high-latency DMA channels to low-latency DMA channels without the use of a dedicated device manager. Advantageously, the proposed technology provides a split DMA controller that is suitable for systems that aim to minimize area, cost, and energy usage.

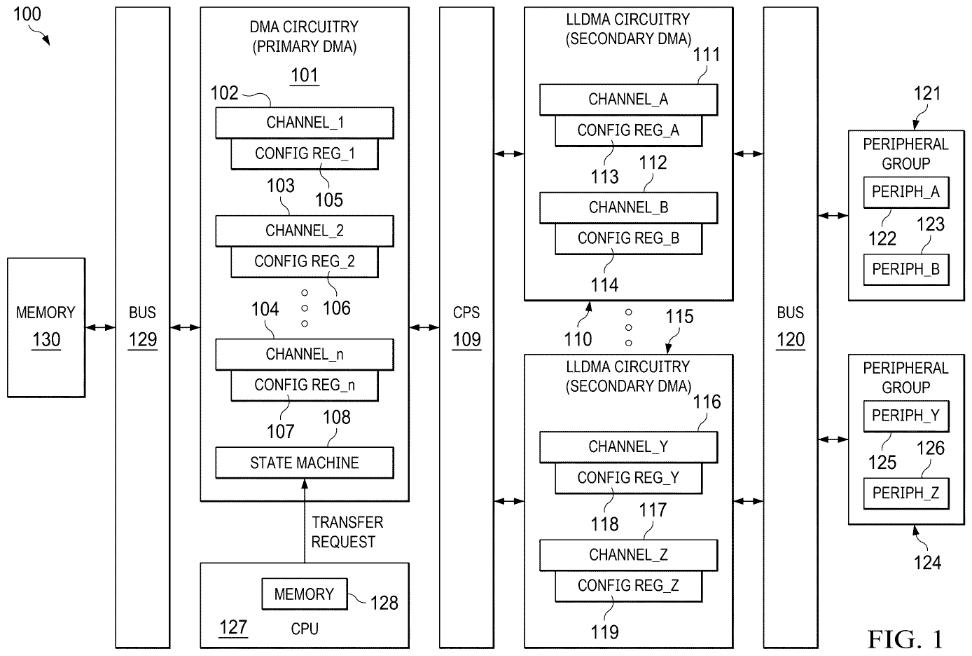

FIG. 1 illustrates system 100 in an implementation. System 100 is representative of an exemplary system that employs a DMA controller for performing various data transfer operations. For example, system 100 may depict a low-cost system, such as an automotive system, industrial system, or consumer device, that utilizes a split DMA controller for exchanging data between a high-latency memory and various low-latency peripherals. System 100 includes, but is not limited to, DMA circuitry 101, configurable packet switch (CPS) 109, low-latency DMA (LLDMA) circuitries 110 and 115, bus 120, peripheral groups 121 and 124, central processing unit (CPU) 127, bus 129, and memory 130.

DMA circuitry 101 represents the primary DMA portion of a split DMA controller. For example, DMA circuitry 101 may support high-latency circuitry, capable of interfacing with a high-latency memory, such as flash memory. In an implementation, DMA circuitry 101 receives transfer requests from an associated CPU. A transfer request refers to a request for data to be moved from a source to one or more destinations. For example, CPU 127 may supply transfer requests to DMA circuitry 101, requesting data to be transferred between memory 130 and the peripherals of peripheral groups 121 and 124. DMA circuitry 101 includes, but is not limited to, circuitry for primary DMA channels 102, 103, and 104, and state machine 108.

Primary DMA channels 102, 103, and 104 represent a number of logical channels that transfer data to and from an associated memory. For example, primary DMA channels 102, 103, and 104 may depict hardware, software, firmware, or a combination thereof that transfer data to and from memory 130. In an implementation, each of primary DMA channels 102, 103, and 104 corresponds to a distinct section within memory 130. For example, primary DMA channel 102 may access data stored within a first address range of memory 130, primary DMA channel 103 may access data stored within a second address range of memory 130, and primary DMA channel 104 may access data stored within a third address range of memory 130, such that the first, second, and third address ranges span the full address space of memory 130. In another implementation, each of primary DMA channels 102, 103, and 104 is capable of accessing data from any location within memory 130. For example, primary DMA channels 102, 103, and 104 may each have access to the full address space of memory 130. In either case, primary DMA channels 102, 103, and 104 function as high-latency DMA channels, optimized for handling large-volume data transfers where relatively high start-up latency is expected and relatively large data transfers are possible after start-up. For example, primary DMA channels 102, 103, and 104 may each be associated with a first-in, first-out (FIFO) buffer that is capable of storing large amounts of data.

In an implementation, primary DMA channels 102, 103, and 104 are each associated with a configuration register. More specifically, primary DMA channel 102 is associated with configuration register 105, primary DMA channel 103 is associated with configuration register 106, and primary DMA channel 104 is associated with configuration register 107. Configuration registers 105, 106, and 107 are representative of registers that allow system 100 to temporarily pair a respective primary DMA channel to the appropriate secondary DMA channel. For example, configuration registers 105, 106, and 107 may each be configured to store the channel identifier (ID) of an associated secondary DMA channel. In an implementation, when requested, state machine 108 populates configuration registers 105, 106, and 107 with the channel IDs of secondary DMA channels 111, 112, 116, and 117.

State machine 108 is representative of circuitry that is responsible for establishing the connections for servicing a transfer request. For example, state machine 108 may depict a hardware state machine that is configured to enable the appropriate pathways for exchanging data between memory 130 and the peripherals of peripheral groups 121 and 124. In an implementation, state machine 108 receives transfer requests from CPU 127, and in response, pairs the DMA channels for servicing the transfer request. For example, if CPU 127 issues a transfer request to transfer data from memory 130 to an associated peripheral, then state machine 108 identifies primary and secondary DMA channels for servicing the transfer request. Once identified, state machine 108 pairs the identified primary DMA channel with the identified secondary DMA channel.

To establish the pairing between the identified DMA channels, state machine 108 stores the channel ID of the identified secondary DMA channel within the configuration register of the identified primary DMA channel, and vice versa. For example, to establish the pairing between primary DMA channel 103 and secondary DMA channel 112, state machine 108 writes the channel ID of secondary DMA channel 112 to configuration register 106 and writes the channel ID of primary DMA channel 103 to configuration register 114. As a result, state machine 108 enables the path in CPS 109 which connects primary DMA channel 103 to secondary DMA channel 112.

In an implementation, state machine 108 is further responsible for tearing down a previously enabled path. For example, CPU 127 may supply a teardown request to state machine 108, requesting state machine 108 to disable the path that connects primary DMA channel 103 to secondary DMA channel 112. In response, state machine 108 removes the channel ID of secondary DMA channel 112 from configuration register 106 and further removes the channel ID of primary DMA channel 103 from configuration register 114. As a result, state machine 108 disables the path in CPS 109 which connects primary DMA channel 103 to secondary DMA channel 112.

CPS 109 is representative of circuitry that includes pathways for connecting the primary DMA channels of DMA circuitry 101 to the secondary DMA channels of LLDMA circuitries 110 and 115. For example, CPS 109 may depict a crossbar switch that includes at least twelve pathways for connecting primary DMA channels 102, 103, and 104 to secondary DMA channels 111, 112, 116, and 117. In an implementation, CPS 109 includes dedicated pathways that allow state machine 108 to communicate with LLDMA circuitries 110 and 115. For example, CPS 109 may include pathways that allow state machine 108 to populate the configuration registers of LLDMA circuitries 110 and 115.

LLDMA circuitry 110 and LLDMA circuitry 115 represent the secondary DMA portion of a split DMA controller. For example, LLDMA circuitries 110 and 115 may support low-latency circuitries, each capable of interfacing with a respective low-latency peripheral group. It should be noted that system 100 is not limited to LLDMA circuitries 110 and 115, but for the purposes of explanation, LLDMA circuitries 110 and 115 will be discussed herein. This specification is not meant to limit the applications of system 100, but rather, to provide an example. LLDMA circuitry 110 includes secondary DMA channels 111 and 112, while LLDMA circuitry 115 includes secondary DMA channels 116 and 117.

Secondary DMA channels 111 and 112, as well as secondary DMA channels 116 and 117, are representative of logical channels that transfer data to and from a respective peripheral. For example, secondary DMA channels 111, 112, 116, and 117 may depict hardware, software, firmware, or a combination thereof that respectively transfer data to and from peripherals 122, 123, 125, and 126. As such, the number of enabled secondary DMA channels within an LLDMA circuit may correspond to the number of peripherals within the corresponding peripheral group. In an implementation, secondary DMA channels 111, 112, 116, and 117 function as low-latency DMA channels, optimized for handling small-volume data transfers. For example, secondary DMA channels 111, 112, 116, and 117 may each be associated with a FIFO buffer that is only capable of storing small amounts of data. In an implementation, secondary DMA channels 111, 112, 116, and 117 are each associated with a configuration register. More specifically, secondary DMA channel 111 is associated with configuration register 113, secondary DMA channel 112 is associated with configuration register 114, secondary DMA channel 116 is associated with configuration register 118, and secondary DMA channel 117 is associated with configuration register 119.

Configuration registers 113, 114, 118, and 119 are representative of registers that allow system 100 to temporarily pair a respective secondary DMA channel to the appropriate primary DMA channel. For example, configuration registers 113, 114, 118, and 119 may each be configured to store the channel ID of an associated primary DMA channel. In an implementation, when requested by CPU 127, state machine 108 populates configuration registers 113, 114, 118, and 119 with the channel IDs of primary DMA channels 102, 103, and 104. For example, if CPU 127 requests for data to be transferred from memory 130 to peripheral 123, then state machine 108 may write the channel ID of secondary DMA channel 112 to configuration register 107 and write the channel ID of primary DMA channel 104 to configuration register 114. State machine 108 may then instruct DMA circuitry 101 to access the requested data from memory 130 via bus 129 and transmit the data from primary DMA channel 104 to secondary DMA channel 112 using CPS 109. Once transmitted, LLDMA circuitry 110 may deliver the data to peripheral 123 via bus 120.

Bus 120 is representative of circuitry that facilitates the transmission of data between the secondary DMA portion of a split DMA controller and various low-latency peripherals. For example, bus 120 may transfer data between LLDMA circuitry 110 and peripheral group 121, as well as between LLDMA circuitry 115 and peripheral group 124. It should be noted that LLDMA circuitries 110 and 115 may each be coupled to a distinct data bus, but for the purposes of explanation, bus 120 will be explained herein. This specification is not meant to limit the applications of system 100, but rather to provide an example. In an implementation, bus 120 depicts a bidirectional bus that transfers small amounts of data. For example, the width of bus 120 may be equal to 8-bits, 16-bits, or 32-bits. As such, bus 120 is well-suited for transferring data between LLDMA circuitries 110 and 115 and the low-latency peripherals of peripheral groups 121 and 124.

Peripheral group 121 and peripheral group 124 each represent a collection of low-latency devices, such that peripheral group 121 includes peripherals 122 and 123, while peripheral group 124 includes peripherals 125 and 126. Peripherals 122, 123, 125, and 126 are representative of low-latency devices, such as I/O devices, sensors, communication devices/interfaces (e.g., SPI, I2C, UART), or another low-latency peripheral of the like. In an implementation, the peripherals within peripheral groups 121 and 124 include peripherals that operate out-of-phase with each other. For example, if a first peripheral (e.g., peripheral 122) of peripheral group 121 is active, then the remaining peripherals of peripheral group 121 (e.g., peripheral 123) are inactive. Similarly, if a first peripheral (e.g., peripheral 126) of peripheral group 124 is active, then the remaining peripherals of peripheral group 124 (e.g., peripheral 125) are inactive. In some implementations, the peripherals within peripheral groups 121 and 124 include peripherals that operate at a similar clock-speed. For example, peripherals 122 and 123 may operate at a first clock speed, while peripherals 125 and 126 operate at a second clock speed that is either faster or slower than the first clock speed.

In an implementation, peripherals 122, 123, 125, and 126 are each mapped to a corresponding secondary DMA channel. More specifically, peripheral 122 is associated with secondary DMA channel 111, peripheral 123 is associated with secondary DMA channel 112, peripheral 125 is associated with secondary DMA channel 116, and peripheral 126 is associated with secondary DMA channel 117. Accordingly, each peripheral of peripheral groups 121 and 124 may transmit and receive data via the respective secondary DMA channel. For example, CPU 127 may issue a request for data to be transferred from memory 130 to peripheral 125, and in response, state machine 108 enables the appropriate pathways for transmitting the data from secondary DMA channel 116 to peripheral 125. Alternatively, CPU 127 may issue a request for data to be transferred from peripheral 125 to memory 130, and in response, state machine 108 enables the appropriate pathways for transmitting the data from secondary DMA channel 116 to memory 130.

CPU 127 is representative of circuitry that manages the operations of system 100. For example, if system 100 is implemented within the automotive context, then CPU 127 may execute program code related to motor control, airbag deployment, infotainment, and other functionalities of the like. In an implementation, CPU 127 executes program code stored in CPU memory 128.

CPU memory 128 is representative of a memory that stores data, instructions, and the like for CPU 127. For example, CPU memory 128 may depict cache memory, static random-access memory (SRAM), dynamic random-access memory (DRAM), or another on-chip memory of the like which stores program code for CPU 127, such that in no case is CPU memory 128 a propagated signal. In an implementation, the program code stored by CPU memory 128 causes CPU 127 to issue various types of requests. For example, the program code stored by CPU memory 128 may cause CPU 127 to issue either transfer requests or teardown requests. A transfer request refers to a request to enable a path for transferring data between memory 130 and the peripherals of peripheral groups 121 and 124. Alternatively, a teardown request refers to a request for a previously enabled path to be disabled. In an implementation, CPU 127 interfaces with DMA circuitry 101 via a bus (not shown).

Memory 130 is representative of a memory that stores data, instructions, and the like for system 100. For example, memory 130 may depict flash memory, DRAM, read-only memory (ROM), or another external memory of the like, such that in no case is memory 130 a propagated signal. In an implementation, memory 130 is a relatively high-latency memory capable of storing and transferring large volumes of data. For example, memory 130 may be capable of storing tens of megabytes to several gigabytes of data and transferring the data at up to 1 Gbps or more. In an implementation, DMA circuitry 101 accesses data from memory 130 via bus 129.

Bus 129 is representative of circuitry that facilitates the transmission of data between the primary DMA portion of a split DMA controller and an external memory. For example, bus 129 may transfer data between DMA circuitry 101 and memory 130. In an implementation, bus 129 depicts a bidirectional bus that can transfer large amounts of data. For example, the width of bus 129 may be equal to 64-bits, 128-bits, or greater. As such, bus 129 is well-suited for transferring data between a high-latency memory, such as memory 130, and DMA circuitry 101.

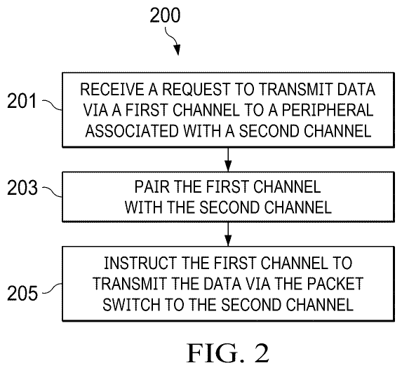

FIG. 2 illustrates method 200 in an implementation. Method 200 is representative of a technique for servicing a transfer request within the context of a split DMA controller. For example, method 200 may provide a technique for transferring data from a high-latency source to a low-latency destination without the use of a dedicated device manager. Method 200 may be implemented in the context of hardware, firmware, or software to cause a system to operate as follows, referring parenthetically to the steps in FIG. 2. For the purposes of explanation, method 200 will be explained with respect to the elements of FIG. 1. This is not meant to limit the applications of method 200, but rather to provide an example for purposes of illustration.

To begin, state machine 108 receives a transfer request from CPU 127 to transmit data from memory 130 to a designated peripheral (step 201). For example, CPU 127 may initiate a request to transfer data from a specific location within memory 130 to peripheral 125. In response, state machine 108 identifies the appropriate primary and secondary DMA channels for servicing the transfer request.

In an implementation, to identify the appropriate primary DMA channel, state machine 108 determines which of primary DMA channels 102, 103, and 104 has access to the requested data as stored in memory 130. For example, CPU 127 may request that data be transferred from a location within memory 130 that only primary DMA channel 103 has access to. In another implementation, to identify the appropriate primary DMA channel, state machine 108 evaluates the availability of primary DMA channels 102, 103, and 104 to determine which channel is currently available for servicing the transfer request. For example, state machine 108 may determine that primary DMA channels 102 and 104 are occupied with servicing other transfer requests, thereby making primary DMA channel 103 the only available channel for servicing the transfer request. As a result, state machine 108 classifies primary DMA channel 103 as the channel for servicing the transfer request.

Next, to determine the appropriate secondary DMA channel, state machine 108 determines which secondary DMA channel is associated with the peripheral that was designated by the transfer request. For example, if CPU 127 outputs a request to transfer data from memory 130 to peripheral 125, then state machine 108 determines that secondary DMA channel 116 is the appropriate channel for servicing the request. Once identified, state machine 108 pairs the appropriate primary DMA channel to the appropriate secondary DMA channel (step 203).

For example, if state machine 108 identifies primary DMA channel 103 and secondary DMA channel 116 as the appropriate DMA channels, then state machine 108 stores the channel ID of secondary DMA channel 116 in configuration register 106. Once stored, state machine 108 may then utilize CPS 109 to store the channel ID of primary DMA channel 103 within configuration register 118. As a result, state machine 108 pairs primary DMA channel 103 with secondary DMA channel 116. More specifically, state machine 108 enables the path in CPS 109 which connects primary DMA channel 103 to secondary DMA channel 116.

Next, state machine 108 instructs DMA circuitry 101 to fetch the requested data from memory 130 and transmit the data to peripheral 125 (step 205). For example, DMA circuitry 101 may access the data from memory 130 and transmit the data to a buffer and/or other communication hardware associated with primary DMA channel 103 via bus 129. Once transmitted, CPS 109 transmits the data from primary DMA channel 103 to a buffer and/or other communication hardware associated with secondary DMA channel 116 via the enabled path. In response, LLDMA circuitry 115 transmits the data from secondary DMA channel 116 to peripheral 125 via bus 120.

In an implementation, after servicing the transfer request, CPU 127 requests state machine 108 to disable the recently enabled path. For example, CPU 127 may output a teardown request to state machine 108, requesting state machine 108 to disable the path within CPS 109 that connects primary DMA channel 103 to secondary DMA channel 116. In response, state machine 108 removes the channel ID of secondary DMA channel 116 from configuration register 106 and removes the channel ID of primary DMA channel 103 from configuration register 118.

Advantageously, method 200 provides a technique for servicing transfer requests within the context of a split DMA controller that does not implement a dedicated device manager. Instead, method 200 leverages a state machine to manage both the pairing and tear down of various DMA channels. As a result, method 200 is particularly well-suited for resource-constrained environments, such as embedded systems or low-power applications, where minimizing area, reducing system cost, and conserving energy are critical design goals.

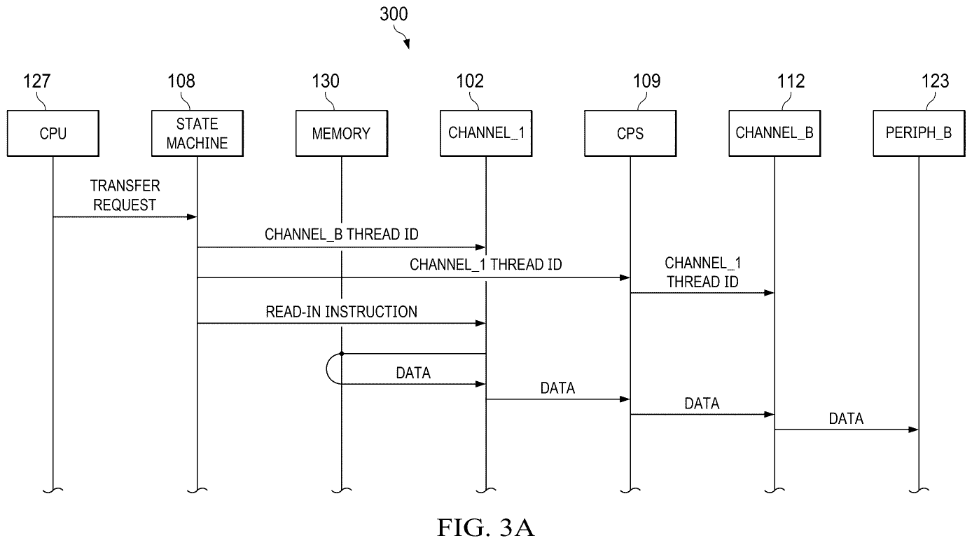

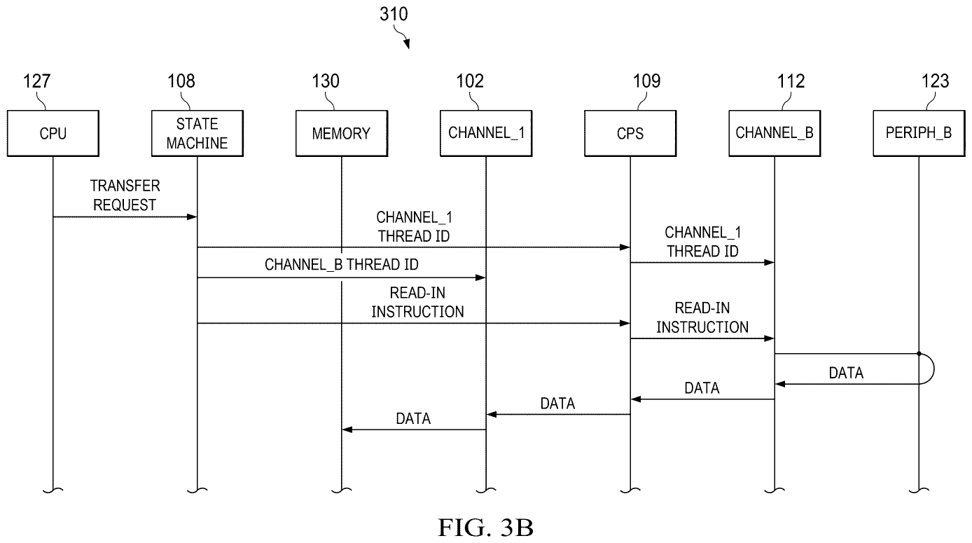

FIG. 3A illustrates sequence diagram 300 in an implementation. Sequence diagram 300 is representative of an operational sequence for servicing a transfer request with respect to the elements of FIG. 1. In an implementation, sequence diagram 300 depicts an operational sequence for transmitting data from a high-latency memory to a low-latency peripheral device. Sequence diagram 300 includes CPU 127, state machine 108, memory 130, primary DMA channel 102, CPS 109, secondary DMA channel 112, and peripheral 123.

To begin, CPU 127 outputs a transfer request to state machine 108, and in response, state machine 108 determines the appropriate channels for servicing the request. For example, CPU 127 may output a request to transfer data from a specific location within memory 130 to peripheral 123, and in response, state machine 108 determines that primary DMA channel 102 and secondary DMA channel 112 are the appropriate channels for servicing the transfer request.

In an implementation, to determine the appropriate primary DMA channel, state machine 108 evaluates the availability of primary DMA channels 102, 103, and 104 to determine which channel is currently available. In another implementation, to determine the appropriate primary DMA channel, state machine 108 determines which of primary DMA channels 102, 103, and 104 has access to the requested data. Alternatively, to determine the appropriate secondary DMA channel, state machine 108 determines which of secondary DMA channels 111, 112, 116, and 117 is associated with peripheral 123.

Next, state machine 108 writes the channel ID of secondary DMA channel 112 to configuration register 105 associated with primary DMA channel 102. For example, state machine 108 may write the thread ID of secondary DMA channel 112 to configuration register 105. State machine 108 may also write the channel ID of primary DMA channel 102 to configuration register 114 associated with secondary DMA channel 112. For example, state machine 108 may use a dedicated path within CPS 109 that is designed for transmitting configuration information to write the thread ID of primary DMA channel 102 to configuration register 114. As a result, state machine 108 enables the path in CPS 109 that connects primary DMA channel 102 to secondary DMA channel 112.

Once enabled, state machine 108 outputs an instruction to DMA circuitry 101, requesting DMA circuitry 101 to read-in the data from memory 130 and write the data to peripheral 123. In response, DMA circuitry 101 accesses the data from memory 130 and transmits the data across primary DMA channel 102 to CPS 109. Next, CPS 109 transmits the data to LLDMA circuitry 110 via the path that was enabled by state machine 108. In response, LLDMA circuitry 110 transmits the data across secondary DMA channel 112 to peripheral 123.

FIG. 3B illustrates sequence diagram 310 in an implementation. Sequence diagram 310 is representative of another operational sequence for servicing a transfer request with respect to the elements of FIG. 1. In an implementation, sequence diagram 310 depicts an operational sequence for transmitting data from a low-latency peripheral device to a high-latency memory. Sequence diagram 310 includes CPU 127, state machine 108, memory 130, primary DMA channel 102, CPS 109, secondary DMA channel 112, and peripheral 123.

To begin, CPU 127 outputs a transfer request to state machine 108, and in response, state machine 108 determines the appropriate channels for servicing the request. For example, CPU 127 may output a request to transfer data from peripheral 123 to a specific location within memory 130, and in response, state machine 108 determines that secondary DMA channel 112 and primary DMA channel 102 are the appropriate channels for servicing the transfer request.

Next, state machine 108 pairs secondary DMA channel 112 with primary DMA channel 102. For example, state machine 108 may use the path within CPS 109 that is dedicated to transmitting configuration information to write the thread ID of primary DMA channel 102 to configuration register 114 associated with secondary DMA channel 112. State machine 108 may also write the channel ID of secondary DMA channel 112 to configuration register 105 associated with primary DMA channel 102. As a result, state machine 108 enables the path in CPS 109 that connects secondary DMA channel 112 to primary DMA channel 102.

Finally, after enabling the desired path, state machine 108 outputs an instruction to LLDMA circuitry 110 (e.g., the portion of LLDMA circuitry associated with secondary DMA channel 112) via CPS 109, requesting LLDMA circuitry 110 to read-in the data from peripheral 123 and write the data to memory 130. In response, LLDMA circuitry 110 accesses the data from peripheral 123 and transmits the data across secondary DMA channel 112 to CPS 109. Next, CPS 109 transmits the data to DMA circuitry 101 via the path that was enabled by state machine 108. In response, DMA circuitry 101 transmits the data across secondary DMA channel 112 to the specified location within memory 130.

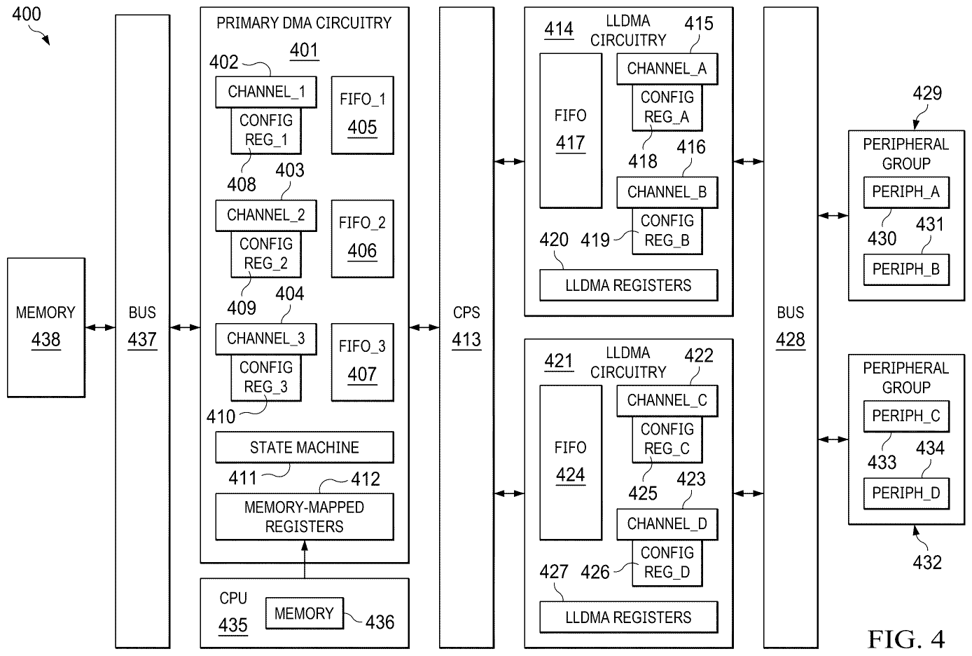

FIG. 4 illustrates system 400 in an implementation. System 400 is representative of another exemplary system that employs a split DMA controller for performing various data transfer operations. For example, system 400 may represent system 100 of FIG. 1. System 400 includes, but is not limited to, primary DMA circuitry 401, CPS 413, LLDMA circuitries 414 and 421, bus 428, peripheral groups 429 and 432, CPU 435, bus 437, and memory 438.

Primary DMA circuitry 401 represents the primary portion of a split DMA controller. For example, primary DMA circuitry 401 may depict circuitry (e.g., DMA circuitry 101) that is capable of interfacing with a high-latency memory. Primary DMA circuitry 401 includes, but is not limited to, primary DMA channels 402, 403, and 404, FIFO buffers 405, 406, and 407, configuration registers 408, 409, and 410, state machine 411, and memory-mapped registers (MMRs) 412.

Primary DMA channels 402, 403, and 404 represent logical channels (e.g., primary DMA channels 102, 103, and 104) that transfer data to and from an associated memory. For example, primary DMA channels 402, 403, and 404 may depict hardware, software, firmware, or a combination thereof, capable of performing large-volume data transfers with respect to memory 438 and/or other high-latency devices. In an implementation, each channel of primary DMA channels 402, 403, and 404 corresponds to a specific section within memory 438. For example, primary DMA channel 402 may access data stored within a first address range of memory 438, primary DMA channel 403 may access data stored within a second address range of memory 438, and primary DMA channel 404 may access data stored within a third address range of memory 438, such that the first, second, and third address ranges span the full address space of memory 438. In an implementation, each channel of primary DMA channels 402, 403, and 404 is associated with a FIFO buffer and a configuration register. For example, primary DMA channel 402 may be associated with FIFO buffer 405 and configuration register 408, primary DMA channel 403 may be associated with FIFO buffer 406 and configuration register 409, and primary DMA channel 404 may be associated with FIFO buffer 407 and configuration register 410.

FIFO buffers 405, 406, and 407 are representative of local memories that store transmission data for a respective primary DMA channel. For example, FIFO buffers 405, 406, and 407 may depict memories that respectively store transmission data for primary DMA channels 402, 403, and 404. In an implementation, FIFO buffers 405, 406, and 407 are housed by an on-chip memory. For example, primary DMA circuitry 401 may include cache memory, SRAM, DRAM, or another on-chip memory of the like that includes FIFO buffers 405, 406, and 407. In another implementation, FIFO buffers 405, 406, and 407 are housed by an off-chip memory. For example, FIFO buffers 405, 406, and 407 may be stored by memory 438. In either case, FIFO buffers 405, 406, and 407 depict local memories that enable primary DMA circuitry 401 to respectively transfer data across primary DMA channels 402, 403, and 404.

Configuration registers 408, 409, and 410 are representative of registers that allow system 400 to temporarily pair a respective primary DMA channel to the appropriate secondary DMA channel. For example, configuration registers 408, 409, and 410 may each be configured to store the channel ID of an associated secondary DMA channel. In an implementation, configuration registers 408, 409, and 410 are populated by state machine 411.

State machine 411 is representative of circuitry (e.g., state machine 108) that is capable of servicing transfer requests. For example, state machine 411 may depict a hardware state machine that establishes the connections for transferring data between memory 438 and the peripherals of peripheral groups 429 and 432. In an implementation, state machine 411 receives transfer requests from CPU 435, and in response, pairs the DMA channels for servicing the transfer request. For example, if CPU 435 issues a transfer request to transfer data from memory 438 to peripheral 431, then state machine 411 identifies the primary and secondary DMA channels for servicing the transfer request and responsively pairs said channels together. In an implementation, state machine 411 receives transfer requests via MMRs 412.

MMRs 412 are representative of registers that indicate whether a respective DMA channel is available for transferring data to or from a specific peripheral. For example, MMRs 412 may include a first set of MMRs corresponding to primary DMA channel 402, a second set of MMRs corresponding to primary DMA channel 403, a third set of MMRs corresponding to primary DMA channel 404, and a fourth set of MMRs corresponding to secondary DMA channels 415, 416, 422, and 423. The first set of MMRs includes four registers that indicate the availability of primary DMA channel 402 with respect to peripherals 430, 431, 433, and 434. The second set of MMRs includes four registers that indicate the availability of primary DMA channel 403 with respect to peripherals 430, 431, 433, and 434. The third set of MMRs includes four registers that indicate the availability of primary DMA channel 404 with respect to peripherals 430, 431, 433, and 434. The fourth set of MMRs includes a first register that indicates the availability of secondary DMA channel 415 with respect to peripheral 430, a second register that indicates the availability of secondary DMA channel 416 with respect to peripheral 431, a third register that indicates the availability of secondary DMA channel 422 with respect to peripheral 433, and a fourth register that indicates the availability of secondary DMA channel 423 with respect to peripheral 434. As such, MMRs 412 includes at least sixteen registers for indicating the availability of primary DMA channels 402, 403, and 404, and secondary DMA channels 415, 416, 422, and 423.

In an implementation, CPU 435 supplies transfer requests to state machine 411 via MMRs 412. For example, if CPU 435 wishes to transfer data from a specific location within memory 438 to peripheral 431, then CPU 435 identifies which primary DMA channel has access to the requested data. Once identified, CPU 435 attempts to enable the appropriate MMR for servicing the transfer request. For example, if CPU 435 wishes to transfer data from a specific location within memory 438 to peripheral 431, and CPU 435 identifies primary DMA channel 404 as the channel which has access to the requested data, then CPU 435 checks if the MMR corresponding to primary DMA channel 404 servicing peripheral 431 is enabled or disabled.

If the MMR is enabled, then CPU 435 determines that primary DMA channel 404 is currently unavailable for servicing the transfer request. In an implementation, if CPU 435 determines that the desired MMR is enabled, then CPU 435 determines whether to disable said MMR. For example, CPU 435 may determine if primary DMA channel 404 and/or secondary DMA channel 416 are currently occupied servicing a separate transfer request. If either channel is occupied, then CPU 435 waits to disable the MMR corresponding to primary DMA channel 404 servicing peripheral 431. Alternatively, if neither channel is occupied, then CPU 435 disables the MMR corresponding to primary DMA channel 404 servicing peripheral 431. Once disabled, CPU 435 may then re-enable the MMR to trigger state machine 411 to service the transfer request.

Alternatively, if the MMR is disabled, then CPU 435 determines that primary DMA channel 404 is currently available for servicing the transfer request and responsively enables the MMR. As a result, CPU 435 triggers state machine 411 to service the transfer request. In an implementation, to service the transfer request, state machine 411 pairs the DMA channels that correspond to the enabled MMR. For example, if CPU 435 enables the MMR that corresponds to primary DMA channel 404 servicing peripheral 431, then state machine 411 identifies which secondary DMA channel (i.e., secondary DMA channel 416) is associated with peripheral 431. Once identified, state machine 411 checks MMRs 412 to determine if secondary DMA channel 416 is available for servicing the transfer request. For example, state machine 411 may check if the MMR corresponding to secondary DMA channel 416 is enabled or disabled.

If the MMR is enabled, then state machine 411 determines that secondary DMA channel 416 is currently unavailable for servicing the transfer request and responsively issues a fault indicator. For example, state machine 411 may output a warning to CPU 435, indicating that the transfer request cannot be serviced. Alternatively, if the MMR is disabled, then state machine 411 determines that secondary DMA channel 416 is currently available for servicing the transfer request and responsively enables the MMR. Once enabled, state machine 411 writes the channel ID of secondary DMA channel 416 to configuration register 410 and writes the channel ID of primary DMA channel 404 to configuration register 419. As a result, state machine 411 enables the path in CPS 413 which connects primary DMA channel 404 to secondary DMA channel 416.

In another implementation, CPU 435 may also supply teardown requests to state machine 411 via MMRs 412. A teardown request refers to a request to disable a path within CPS 413 that was previously enabled. For example, if CPU 435 wishes to tear down the path in CPS 413 which connects primary DMA channel 402 to secondary DMA channel 416, then CPU 435 may disable the MMR corresponding to primary DMA channel 402 servicing peripheral 431. As a result, CPU 435 triggers state machine 411 to service the teardown request.

To service the teardown request, state machine 411 unpairs the DMA channels that correspond to the disabled MMR. For example, if CPU 435 disables the MMR corresponding to primary DMA channel 402 servicing peripheral 431, then state machine 411 removes the channel ID of secondary DMA channel 416 from configuration register 408 and removes the channel ID of primary DMA channel 402 from configuration register 114. Once removed, state machine 411 disables the MMR corresponding to secondary DMA channel 416. As a result, state machine 411 disables the path in CPS 413 which connects primary DMA channel 402 to secondary DMA channel 416, thereby making primary DMA channel 402 and secondary DMA channel 416 available for servicing another transfer request.

CPS 413 is representative of circuitry (e.g., CPS 109) that includes pathways for connecting the primary DMA channels of primary DMA circuitry 401 to the secondary DMA channels of LLDMA circuitries 414 and 421. For example, CPS 413 may depict a crossbar switch that includes at least twelve pathways for connecting primary DMA channels 402, 403, and 404 to secondary DMA channels 415, 416, 422, and 423. In an implementation, CPS 413 includes dedicated pathways that allow state machine 411 to communicate with LLDMA circuitries 414 and 421. For example, CPS 413 may include pathways that allow state machine 411 to populate the configuration registers of LLDMA circuitries 414 and 421.

LLDMA circuitry 414 and LLDMA circuitry 421 represent the secondary DMA portion (e.g., LLDMA circuitries 110 and 115) of a split DMA controller. For example, LLDMA circuitries 414 and 421 may depict circuitries that are capable of interfacing with a respective low-latency peripheral group. LLDMA circuitry 414 includes, but is not limited to, secondary DMA channels 415 and 416, FIFO buffer 417, configuration registers 418 and 419, and LLDMA registers 420. Meanwhile, LLDMA circuitry 421 includes, but is not limited to, secondary DMA channels 422 and 423, FIFO buffer 424, configuration registers 425 and 426, and LLDMA registers 427.

Secondary DMA channels 415 and 416, as well as secondary DMA channels 422 and 423, are representative of logical channels (e.g., secondary DMA channels 111, 112, 116, and 117) that transfer data to and from a respective low-latency peripheral. For example, secondary DMA channels 415, 416, 422, and 423 may depict hardware, software, firmware, or a combination thereof that respectively transfer small amounts of data to and from peripherals 430, 431, 433, and 434. In an implementation, the secondary DMA channels of an LLDMA circuit are associated with a FIFO buffer and each associated with a configuration register. For example, secondary DMA channels 415 and 416 are both associated with FIFO buffer 417 and respectively associated with configuration registers 418 and 419. Similarly, secondary DMA channels 422 and 423 are both associated with FIFO buffer 424 and respectively associated with configuration registers 425 and 426.

FIFO buffers 417 and 424 are representative of local memories that store transmission data for a respective set of secondary DMA channels. For example, FIFO buffer 417 may depict a memory that stores transmission data for secondary DMA channels 415 and 416, while FIFO buffer 424 depicts a memory that stores transmission data for secondary DMA channels 422 and 423. Due to the differences in the ways memory 438 and peripherals 430, 431, and 433, and 434 transfer data, the sizes of FIFO buffers 405, 406, and 407 may be greater than the sizes of FIFO buffers 417 and 424. In an implementation, FIFO buffers 417 and 424 are housed by an on-chip memory. For example, LLDMA circuitries 414 and 421 may each include cache memory, SRAM, DRAM, or another on-chip memory of the like that respectively stores FIFO buffers 417 and 424. In another implementation, FIFO buffers 417 and 424 are housed by an off-chip memory. For example, FIFO buffers 417 and 424 may be stored by memory 438. In either case, FIFO buffers 417 and 424 depict local memories that respectively enable LLDMA circuitries 414 and 421 to transfer data across secondary DMA channels 415, 416, 422, and 423.

Configuration registers 418, 419, 425, and 426 represent registers that allow system 400 to temporarily pair a respective secondary DMA channel to the appropriate primary DMA channel. For example, configuration registers 418, 419, 425, and 426 may each be configured to store the channel ID of an associated primary DMA channel. In an implementation, when requested by CPU 435, state machine 411 writes to, or removes data from configuration registers 418, 419, 425, and 426. For example, if CPU 435 outputs a transfer request to state machine 411, then state machine 411 may store the channel ID of the requested primary and secondary DMA channels within the corresponding configuration registers. Alternatively, if CPU 435 outputs a teardown request to state machine 411, then state machine 411 may remove the channel IDs of the requested primary and secondary DMA channels from the corresponding configuration registers.

LLDMA registers 420 and 427 are representative of registers that respectively store information related to LLDMA circuitries 414 and 421. For example, LLDMA registers 420 may store the channel IDs (e.g., thread IDs) of secondary DMA channels 415 and 416, the number of available credits within FIFO buffer 417, the amount of available space within FIFO buffer 417, and the width of bus 428. Similarly, LLDMA registers 427 may store the channel IDs (e.g., thread IDs) of secondary DMA channels 422 and 423, the number of available credits within FIFO buffer 424, the amount of available space within FIFO buffer 424, and the width of bus 428. In an implementation, state machine 411 references LLDMA registers 420 and 427 to service various transfer requests. For example, if state machine 411 is requested to pair primary DMA channel 403 to secondary DMA channel 415, then state machine 411 may access LLDMA registers 420 to determine if FIFO buffer 417 has enough room for servicing the transfer request.

Bus 428 is representative of circuitry (e.g., bus 120) that facilitates the transmission of data between the secondary DMA portion of a split DMA controller and various low-latency peripherals. For example, bus 428 may transfer data between LLDMA circuitry 414 and peripheral group 429, as well as between LLDMA circuitry 421 and peripheral group 432. It should be noted that LLDMA circuitries 414 and 421 may each be coupled to a distinct data bus, but for the purposes of explanation, bus 428 will be explained herein. In an implementation, bus 428 depicts a bidirectional bus that is capable of transferring small amounts of data. For example, the width of bus 428 may be equal to 8-bits, 16-bits, or 32-bits. As such, bus 428 is well-suited for transferring data between LLDMA circuitries 414 and 421 and the low-latency peripherals of peripheral groups 429 and 432.

Peripheral group 429 and peripheral group 432 each represent a collection of low-latency devices (e.g., peripheral groups 121 and 124), such that peripheral group 429 includes, but is not limited to, peripherals 430 and 431 while peripheral group 432 includes, but is not limited to, peripherals 433 and 434. Peripherals 430, 431, 433, and 434 represent low-latency devices, such as I/O devices, sensors, communication devices/interfaces (e.g., SPI, I2C, UART), or another low-latency peripheral of the like. In an implementation, the peripherals of system 400 are formed into various groups based on a shared communication protocol, clock-speed, or the activity of the peripherals. For example, peripheral group 429 may include multiple SPI peripherals, multiple peripherals that operate at the same clock-speed, or multiple peripherals that operate out-of-phase with each other. In an implementation, peripherals 430, 431, 433, and 434 are each mapped to a corresponding secondary DMA channel. More specifically, peripheral 430 corresponds to secondary DMA channel 415, peripheral 431 corresponds to secondary DMA channel 416, peripheral 433 corresponds to secondary DMA channel 422, and peripheral 434 corresponds to secondary DMA channel 423. Accordingly, each peripheral of peripheral groups 429 and 432 may transmit data to or receive data from memory 438 via the respective secondary DMA channel.

CPU 435 is representative of circuitry that manages the operations of system 400. For example, CPU 435 may be representative of CPU 127 of FIG. 1. In an implementation, CPU 435 executes program code stored by CPU memory 436. CPU memory 436 is a memory that stores data, instructions, and the like for CPU 435. For example, CPU memory 436 may depict cache memory, SRAM, DRAM, or another on-chip memory of the like which stores program code for CPU 435, such that in no case is CPU memory 436 a propagated signal. In an implementation, the program code stored by CPU memory 436 causes CPU 435 to issue both transfer requests and teardown requests. For example, the program code stored by CPU memory 436 may cause CPU 435 to enable or disable the registers of MMRs 412. In an implementation, CPU 435 interfaces with MMRs 412 via a bus (not shown).

Memory 438 is representative of a high-latency memory (e.g., memory 130) that stores data, instructions, and the like for system 400. For example, memory 438 may depict flash memory, DRAM, ROM, or another external memory of the like, such that in no case is memory 438 a propagated signal. In an implementation, primary DMA circuitry 401 accesses data from memory 438 via bus 437.

Bus 437 is representative of circuitry (e.g., bus 129) that facilitates the transmission of data between the primary DMA portion of a split DMA controller and an external memory. For example, bus 437 may transfer data between primary DMA circuitry 401 and memory 438. In an implementation, bus 437 depicts a bidirectional bus that can transfer large amounts of data. For example, the width of bus 437 may be equal to 64-bits, 128-bits, or greater. As such, bus 437 is well-suited for transferring data between a high-latency memory, such as memory 438, and primary DMA circuitry 401.

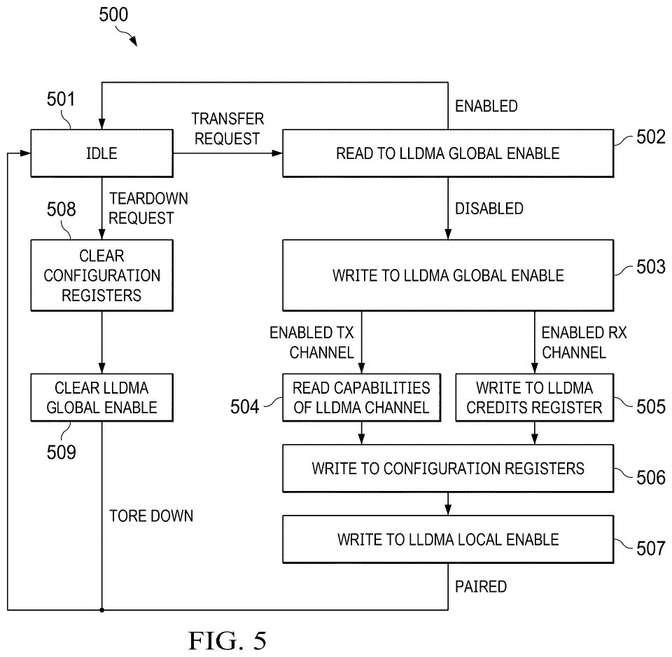

FIG. 5 illustrates state machine diagram 500 in an implementation. State machine diagram 500 provides a visualization for the logic that is employed by a state machine of a split DMA controller as presented herein. For example, state machine diagram 500 may provide a visualization for the logic that is employed by either state machine 108 of FIG. 1 or state machine 411 of FIG. 4. For the purposes of explanation, state machine diagram 500 will be explained with the elements of FIG. 4. This specification is not meant to limit the applications of state machine diagram 500, but rather to provide an example.

To begin, state machine 411 starts within idle state 501. Idle state 501 describes the operative mode for when state machine 411 is awaiting to receive a DMA request from CPU 435. For example, when operating under idle state 501, state machine 411 may observe MMRs 412 to determine when CPU 435 has issued a transfer request or a teardown request.

In an implementation, if CPU 435 enables an MMR corresponding to a primary DMA channel servicing a specific peripheral, then state machine 411 is triggered to service a transfer request. For example, CPU 435 may enable the MMR corresponding to primary DMA channel 404 servicing peripheral 433, and in response, state machine 411 transitions to read state 502.

Read state 502 describes the operative mode for when state machine 411 determines if the secondary DMA channel is available for servicing the transfer request. In an implementation, when operating under read state 502, state machine 411 first identifies the secondary DMA channel for servicing the transfer request. For example, if CPU 435 enabled the MMR corresponding to primary DMA channel 404 servicing peripheral 433, then state machine 411 identifies secondary DMA channel 422 as the secondary DMA channel for servicing the transfer request. Once identified, state machine 411 checks MMRs 412 to determine if the MMR corresponding to secondary DMA channel 422 is enabled or disabled. If enabled, state machine 411 determines that secondary DMA channel 422 is unavailable, and returns to idle state 501. Alternatively, if disabled, state machine 411 transitions to write state 503.

Write state 503 describes the operative mode for when state machine 411 enables the secondary DMA channel for servicing the transfer request. For example, if state machine 411 identifies secondary DMA channel 422 as the secondary DMA channel for servicing the transfer request, then state machine 411 may, when operating under write state 503, enable the MMR of MMRs 412 that corresponds to secondary DMA channel 422. Once enabled, state machine 411 determines if the transfer request corresponds to a transmit request or a receive request. A transmit request refers to a request for data to be transmitted from memory 438. Alternatively, a receive request refers to a request for data to be received by memory 438.

In an implementation, if state machine 411 determines that the transfer request corresponds to a transmit request, then, state machine 411 transitions to read state 504. Read state 504 describes the operative mode for when state machine 411 determines if the corresponding FIFO buffer includes enough space for accommodating the transmit request. For example, state machine 411 may evaluate LLDMA registers 427 to determine whether FIFO buffer 424 includes enough space to service the transmit request. If sufficient, state machine 411 transitions to write state 506. Otherwise, state machine 411 remains in read state 504 until enough space becomes available within FIFO buffer 424.

In another implementation, if state machine 411 determines that the transfer request corresponds to a receive request, then, state machine 411 transitions to write state 505. Write state 505 describes the operative mode for when state machine 411 updates the number of available credits within the corresponding FIFO buffer. For example, state machine 411 may write to LLDMA registers 427 to decrement the number of available credits within FIFO buffer 424. Once written, state machine 411 transitions to write state 506.

Write state 506 describes the operative mode for when state machine 411 pairs the DMA channels for servicing the transfer request. In an implementation, to pair the DMA channels for servicing the transfer request, state machine 411 writes the channel IDs of said channels to the corresponding configuration registers. For example, state machine 411 may write the thread ID of secondary DMA channel 422 to configuration register 410. State machine 411 may then utilize a dedicated path within CPS 413 to write the thread ID of primary DMA channel 404 to configuration register 425. As a result, state machine 411 enables the path in CPS 413 that connects primary DMA channel 404 to secondary DMA channel 422. Once enabled, state machine 411 transitions to write state 507.

Write state 507 describes the operative mode for when state machine 411 issues the instruction to service the transfer request. For example, when operating under write state 507, state machine 411 may enable a register within LLDMA registers 427 that causes LLDMA circuitry 421 and primary DMA circuitry 401 to perform the operations for servicing the transfer request. Meaning, state machine 411 instructs primary DMA circuitry 401 and LLDMA circuitry 421 to utilize primary DMA channel 404 and FIFO buffer 407, as well as secondary DMA channel 422 and FIFO buffer 424 to route data between memory 438 and peripheral 433. Once instructed, state machine 411 returns to idle state 501.

In another implementation, if CPU 435 disables an MMR corresponding to a primary DMA channel servicing a specific peripheral, then state machine 411 is triggered to service a teardown request. For example, CPU 435 may disable the MMR corresponding to primary DMA channel 404 servicing peripheral 433, thereby causing state machine 411 to transition to clear state 508.

Clear state 508 describes the operative mode for when state machine 411 disables a path within CPS 413 that was previously enabled. For example, when operating under clear state 508, state machine 411 may disable the path within CPS 413 that connects primary DMA channel 404 to secondary DMA channel 422. In an implementation, to disable a path within CPS 413 that connects a primary DMA channel to a secondary DMA channel, state machine 411 removes the channel IDs from the corresponding configuration registers. For example, state machine 411 may remove the thread ID of secondary DMA channel 422 from configuration register 410. State machine 411 may then utilize a dedicated path within CPS 413 to remove the thread ID of primary DMA channel 404 from configuration register 425. As a result, state machine 411 disables the path in CPS 413 that connects primary DMA channel 404 to secondary DMA channel 422. Once disabled, state machine 411 transitions to clear state 509.

Clear state 509 describes the operative mode for when state machine 411 disables the MMR corresponding to a secondary DMA channel, thereby signifying that the channel is available to service additional transfer requests. For example, when operating under clear state 509, state machine 411 may disable the MMR within MMRs 412 that corresponds to secondary DMA channel 422, thereby making secondary DMA channel 422 available to service subsequent transfer requests. Once disabled, state machine 411 returns to idle state 501.

Advantageously, state machine diagram 500 provides a technique for servicing transfer requests within the context of a split DMA controller that does not implement a dedicated device manager.

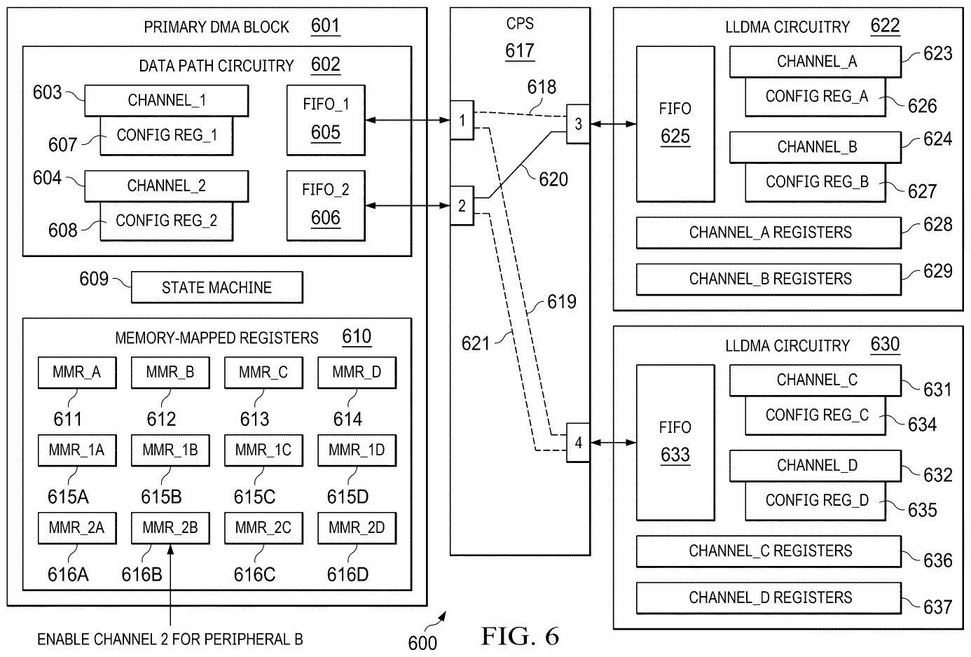

FIG. 6 illustrates operational scenario 600 in an implementation. Operational scenario 600 is representative of a scenario for servicing a transfer request with respect to a split DMA controller. For example, operational scenario 600 may provide a scenario for servicing a transfer request within the context of system 100 or system 400. Operational scenario 600 includes primary DMA block 601, CPS 617, and LLDMA circuitries 622 and 630.

Primary DMA block 601 represents the high-latency portion of a split DMA controller. For example, primary DMA block 601 may be representative of DMA circuitry 101 of FIG. 1 or primary DMA circuitry 401 of FIG. 4. Primary DMA block 601 includes, but is not limited to, data path circuitry 602, state machine 609, and MMRs 610.

Data path circuitry 602 is representative of circuitry that is capable of interfacing with an external memory. For example, data path circuitry 602 may depict circuitry capable of interfacing with a high-latency memory, such as flash memory. Data path circuitry 602 includes, but is not limited to, primary DMA channels 603 and 604, FIFO buffers 605 and 606, and configuration registers 607 and 608.

Primary DMA channels 603 and 604 represent logical channels that transfer data to and from an external memory. For example, primary DMA channels 603 and 604 may be representative of primary DMA channels 102, 103, and 104 of FIG. 1, or primary DMA channels 402, 403, and 404 of FIG. 4. In an implementation, each primary DMA channel of data path circuitry 602 is associated with a respective FIFO buffer and a configuration register. For example, primary DMA channel 603 may be associated with FIFO buffer 605 and configuration register 607, while primary DMA channel 604 may be associated with FIFO buffer 606 and configuration register 608.

FIFO buffers 605 and 606 are representative of local memories that store transmission data for a respective primary DMA channel. For example, FIFO buffers 605 and 606 may depict high-latency memories that respectively store transmission data for primary DMA channels 603 and 604. In an implementation, FIFO buffers 605 and 606 are housed by an on-chip memory. For example, data path circuitry 602 may include cache memory, SRAM, DRAM, or another on-chip memory of the like that stores FIFO buffers 605 and 606. In another implementation, FIFO buffers 605 and 606 are housed by an off-chip memory. For example, FIFO buffers 605 and 606 may be stored by an associated flash memory. In either case, FIFO buffers 605 and 606 depict local memories that enable data path circuitry 602 to respectively transfer data across primary DMA channels 603 and 604.

Configuration registers 607 and 608 are representative of registers that allow a respective primary DMA channel to be paired to the appropriate secondary DMA channel. For example, configuration registers 607 and 608 may each be configured to store the channel ID of an associated secondary DMA channel. More specifically, configuration registers 607 and 608 may store the thread ID of an associated secondary DMA channel. In an implementation, configuration registers 607 and 608 are populated by state machine 609.

State machine 609 is representative of a hardware state machine that enables the pathways for servicing a transfer request. For example, state machine 609 may depict state machine 108 of FIG. 1 or state machine 411 of FIG. 4. In an implementation, state machine 609 receives transfer requests from an associated CPU (e.g., CPU 127 or CPU 435), and in response, pairs the DMA channels for servicing the transfer request. For example, the associated CPU may request state machine 609 to establish the connections for transferring data between a high-latency memory and various low-latency peripherals. In an implementation, state machine 609 receives transfer requests via MMRs 610.

MMRs 610 are representative of registers that indicate whether a respective DMA channel is available for transferring data to or from a specific peripheral. For example, MMRs 610 may be representative of MMRs 412 of FIG. 4. MMRs 610 includes secondary MMRs 611, 612, 613, and 614, primary MMRs 615A, 615B, 615C, and 615D, and primary MMRs 616A, 616B, 616C, and 616D.

Secondary MMRs 611, 612, 613, and 614 are representative of registers that indicate whether a respective secondary DMA channel is currently available. For example, secondary MMR 611 may indicate whether secondary DMA channel 623 is currently available to transfer data to or from an associated peripheral, secondary MMR 612 may indicate whether secondary DMA channel 624 is currently available to transfer data to or from an associated peripheral, secondary MMR 613 may indicate whether secondary DMA channel 631 is currently available to transfer data to or from an associated peripheral, and secondary MMR 614 may indicate whether secondary DMA channel 632 is currently available to transfer data to or from an associated peripheral.

In an implementation, if a secondary MMR is disabled, then the corresponding DMA channel is available to transfer data. For example, if secondary MMR 611 is disabled, then secondary DMA channel 623 is available to transfer data to or from the associated peripheral. Alternatively, if a secondary MMR is enabled, then the corresponding DMA channel is unavailable to transfer data. More specifically, the corresponding DMA channel is occupied servicing a transfer request. For example, if secondary MMR 611 is enabled, then secondary DMA channel 623 is currently occupied transferring data to or from the associated peripheral. In an implementation, secondary MMRs 611, 612, 613, and 614 are enabled or disabled by state machine 609.

Primary MMRs 615A-615D and primary MMRs 616A-616D are representative of registers that indicate whether a respective primary DMA channel is currently available to transfer data to or from a specific peripheral. For example, primary MMR 615A may indicate whether primary DMA channel 603 is currently available to transfer data to or from the peripheral that is associated with secondary DMA channel 623, primary MMR 615B may indicate whether primary DMA channel 603 is currently available to transfer data to or from the peripheral that is associated with secondary DMA channel 624, primary MMR 615C may indicate whether primary DMA channel 603 is currently available to transfer data to or from the peripheral that is associated with secondary DMA channel 631, and primary MMR 615D may indicate whether primary DMA channel 603 is currently available to transfer data to or from the peripheral that is associated with secondary DMA channel 632. Meanwhile, primary MMR 616A may indicate whether primary DMA channel 604 is currently available to transfer data to or from the peripheral that is associated with secondary DMA channel 623, primary MMR 616B may indicate whether primary DMA channel 604 is currently available to transfer data to or from the peripheral that is associated with secondary DMA channel 624, primary MMR 616C may indicate whether primary DMA channel 604 is currently available to transfer data to or from the peripheral that is associated with secondary DMA channel 631, and primary MMR 616D may indicate whether primary DMA channel 604 is currently available to transfer data to or from the peripheral that is associated with secondary DMA channel 632.

In an implementation, if a primary MMR is disabled, then the corresponding DMA channel is available to transfer data. For example, if primary MMR 615A is disabled, then primary DMA channel 603 is available to transfer data to or from the peripheral that is associated with secondary DMA channel 623. Alternatively, if a primary MMR is enabled, then the corresponding DMA channel is unavailable to transfer data. More specifically, the corresponding DMA channel is occupied servicing a transfer request. For example, if primary MMR 615A is enabled, then primary DMA channel 603 is currently occupied transferring data to or from the peripheral that is associated with secondary DMA channel 623. In an implementation, primary MMRs 615A-615D and primary MMRs 616A-616D are enabled or disabled by an associated CPU (e.g., CPU 127 or CPU 435). For example, the associated CPU may supply transfer requests to state machine 609 via primary MMRs 615A-615D and primary MMRs 616A-616D.

CPS 617 is representative of circuitry (e.g., CPS 109 and CPS 413) that includes pathways for connecting the primary DMA channels of data path circuitry 602 to the secondary DMA channels of LLDMA circuitries 622 and 630. For example, CPS 617 may depict a crossbar switch that includes pathways for connecting the FIFO buffers associated with the primary DMA channels to the FIFO buffers associated with the secondary DMA channels. In an implementation, CPS 617 also includes dedicated pathways (not shown) that allow state machine 609 to pair the secondary DMA channels of LLDMA circuitries 622 and 630 to the primary DMA channels of data path circuitry 602. As such, CPS 617 includes, but is not limited to paths 618, 619, 620, and 621.

Paths 618, 619, 620, and 621 are representative of logical connections that allow for the exchange of data between data path circuitry 602 and LLDMA circuitries 622 and 630. More specifically, path 618 is representative of connection that allows primary DMA channel 603 to exchange data with secondary DMA channels 623 and 624 and path 619 is representative of connection that allows primary DMA channel 603 to exchange data with secondary DMA channels 631 and 632. Meanwhile, path 621 is representative of connection that allows primary DMA channel 604 to exchange data with secondary DMA channels 623 and 624 and path 621 is representative of connection that allows primary DMA channel 604 to exchange data with secondary DMA channels 631 and 632. In an implementation, paths 618, 619, 620, and 621 are enabled and disabled by state machine 609.

LLDMA circuitries 622 and 630 represent the low-latency portion of a split DMA controller. For example, LLDMA circuitries 622 and 630 may be representative of LLDMA circuitries 110 and 115 of FIG. 1 or LLDMA circuitries 414 and 421 of FIG. 4. LLDMA circuitry 622 includes, but is not limited to, secondary DMA channels 623 and 624, FIFO buffer 625, configuration registers 626 and 627, LLDMA registers 628, and LLDMA registers 629. Meanwhile, LLDMA circuitry 630 includes, but is not limited to, secondary DMA channels 631 and 632, FIFO buffer 633, configuration registers 634 and 635, LLDMA registers 636, and LLDMA registers 637.

Secondary DMA channels 623 and 624, as well as secondary DMA channels 631 and 632 represent logical channels that transfer data to and from a respective low-latency peripheral. For example, secondary DMA channels 623, 624, 631, and 632 may be representative of secondary DMA channels 111, 112, 116, and 117 of FIG. 1, or secondary DMA channels 415, 416, 422, and 423 of FIG. 4. In an implementation, the secondary DMA channels of an LLDMA circuit are associated with a FIFO buffer and are each associated with a configuration register. For example, secondary DMA channels 623 and 624 are both associated with FIFO buffer 625 and respectively associated with configuration registers 626 and 627. Similarly, secondary DMA channels 631 and 632 are both associated with FIFO buffer 633 and respectively associated with configuration registers 634 and 635.

FIFO buffers 625 and 633 are representative of local memories that store transmission data for a respective set of secondary DMA channels. For example, FIFO buffer 625 may depict a memory that stores transmission data for secondary DMA channels 623 and 624, while FIFO buffer 633 depicts a memory that stores transmission data for secondary DMA channels 631 and 632. In an implementation, FIFO buffers 625 and 633 are housed by an on-chip memory. For example, LLDMA circuitries 622 and 630 may each include cache memory, SRAM, DRAM, or another on-chip memory of the like that respectively stores FIFO buffers 625 and 633. In another implementation, FIFO buffers 625 and 633 are housed by an off-chip memory. For example, FIFO buffers 625 and 633 may be stored by an external memory, such as flash memory. In either case, FIFO buffers 625 and 633 depict local memories that respectively enable LLDMA circuitries 622 and 630 to transfer data across secondary DMA channels 623, 624, 631, and 632.

Configuration registers 626, 627, 634, and 635 are representative of registers that allow a respective secondary DMA channel to be paired to the appropriate primary DMA channel. For example, configuration registers 626, 627, 634, and 635 may each be configured to store the channel ID of an associated primary DMA channel. More specifically, configuration registers 626, 627, 634, and 635 may store the thread ID of an associated primary DMA channel. In an implementation, configuration registers 607 and 608 are populated by state machine 609.

LLDMA registers 628 and 629 are representative of registers that store information related to LLDMA circuitry 622, while LLDMA registers 636, and 637 are representative of registers that store information related to LLDMA circuitry 630. For example, LLDMA registers 628 may store the thread ID of secondary DMA channel 623, the number of available credits within FIFO buffer 625 with respect to secondary DMA channel 623, and the amount of available space within FIFO buffer 625 with respect to secondary DMA channel 623. Similarly, LLDMA registers 629 may store the thread ID of secondary DMA channel 624, the number of available credits within FIFO buffer 625 with respect to secondary DMA channel 624, and the amount of available space within FIFO buffer 625 with respect to secondary DMA channel 624. Meanwhile, LLDMA registers 636 may store the thread ID of secondary DMA channel 631, the number of available credits within FIFO buffer 633 with respect to secondary DMA channel 631, and the amount of available space within FIFO buffer 633 with respect to secondary DMA channel 631. Similarly, LLDMA registers 637 may store the thread ID of secondary DMA channel 632, the number of available credits within FIFO buffer 633 with respect to secondary DMA channel 632, and the amount of available space within FIFO buffer 633 with respect to secondary DMA channel 632. In an implementation, state machine 609 references LLDMA registers 628, 629, 636, and 637 to service various transfer requests. For example, if state machine 609 is requested to pair primary DMA channel 603 to secondary DMA channel 624, then state machine 609 may access LLDMA register 629 to determine if FIFO buffer 625 has enough room for servicing the transfer request.

To begin operational scenario 600, an associated CPU enables primary MMR 616B. In response, state machine 609 determines that the associated CPU wishes to transfer data from an associated memory to the peripheral associated with secondary DMA channel 624. Next, state machine 609 determines if secondary DMA channel 624 is available for servicing the transfer request. For example, state machine 609 may evaluate secondary MMR 612 and determine that secondary MMR 612 is currently disabled. As such, state machine 609 determines that secondary DMA channel 624 is currently available for servicing the transfer request and responsively enables secondary MMR 612.

Next, state machine 609 classifies the transfer request as a transmit request, and in response, checks LLDMA registers 629 to determine that FIFO buffer 625 includes enough space for servicing the request. Once determined, state machine 609 enables the path in CPS 617 that connects primary DMA channel 604 to secondary DMA channel 624. For example, state machine 609 may write the thread ID of secondary DMA channel 624 to configuration register 608. State machine 609 may then utilize a dedicated path (not shown) in CPS 617 to write the thread ID of primary DMA channel 604 to configuration register 627. As a result, state machine 609 enables path 620, thereby connecting FIFO buffer 606 to FIFO buffer 625. Once enabled, state machine 609 instructs data path circuitry 602 to transfer the requested data from primary DMA channel 604 to secondary DMA channel 624 via path 620. More specifically, state machine 609 instructs data path circuitry 602 to transfer the requested data from FIFO buffer 606 to FIFO buffer 625 via path 620.

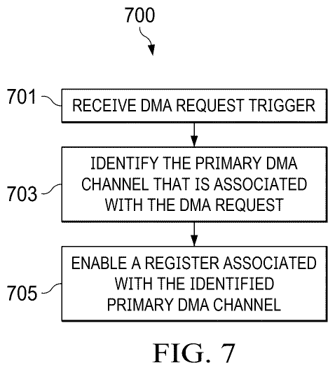

FIG. 7 illustrates method 700 in an implementation. Method 700 is representative of a technique for issuing a transfer request to a split DMA controller that utilizes a state machine to coordinate the pairing of primary and secondary DMA channels required to service the request. For example, method 700 may provide a technique for CPU 127 or CPU 435. Method 700 may be implemented in the context of hardware, firmware, or software to cause a system to operate as follows, referring parenthetically to the steps in FIG. 7. For the purposes of explanation, method 700 will be explained with respect to the elements of FIG. 4. This is not meant to limit the applications of method 700, but rather to provide an example for purposes of illustration.

To begin, CPU 435 is triggered to issue a transfer request (step 701). For example, peripheral 431 may output a request to CPU 435, requesting access to data stored by memory 438. In response, CPU 435 determines the appropriate primary DMA channel for servicing the request (step 703). For example, CPU 435 may identify the location in memory 438 that is storing the requested data. Once identified, CPU 435 may determine which primary DMA channel has access to the identified location. For example, CPU 435 may determine that primary DMA channel 403 has access to the requested data.

Next, CPU 435 determines if the register in MMRs 412 that corresponds to primary DMA channel 403 servicing peripheral 431 is currently enabled. If enabled, CPU 435 determines that primary DMA channel 403 is currently unavailable for servicing the transfer request. Alternatively, if disabled, CPU 435 determines that primary DMA channel 403 is currently available for servicing the transfer request and responsively enables the MMR (step 705). In an implementation, after primary DMA circuitry 401 and LLDMA circuitry 414 service the transfer request, CPU 435 disables the register in MMRs 412 that corresponds to primary DMA channel 403 servicing peripheral 431. As a result, CPU 435 provides an indication that primary DMA channel 403 is available to service a subsequent transfer request.

Advantageously, method 700 provides a technique for issuing transfer requests that does not rely upon a dedicated device manager. Instead, method 700 provides a technique for issuing a transfer request that relies on software. As a result, method 700 is particularly well-suited for resource-constrained environments, where minimizing area, reducing system cost, and conserving energy are critical design goals.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Circuits described herein are reconfigurable to include additional or different components to provide functionality at least partially similar to functionality available prior to the component replacement.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A direct memory access (DMA) controller comprising:
a set of primary DMA channel circuits coupled to a first device;
a set of secondary DMA channel circuits coupled to second devices;
a packet switch coupled to the primary DMA channel circuits and the secondary DMA channel circuits; and
a state machine coupled to the packet switch, wherein the state machine is operable to:
receive a request to transmit data via a first channel circuit of the set of primary DMA channel circuits to a device of the second devices wherein the device is associated with a second channel circuit of the secondary DMA channel circuits; and
in response to the request:
pair the first channel circuit with the second channel circuit; and
instruct the first channel circuit to transmit the data via the packet switch to the second channel circuit.

2. The DMA controller of claim 1, wherein each of the set of primary DMA channel circuits and each of the set of secondary DMA channel circuits are associated with a configuration register.

3. The DMA controller of claim 2, wherein to pair the first channel circuit with the second channel circuit, the state machine is operable to write a channel identifier (ID) of the second channel circuit to the configuration register associated with the first channel circuit.

4. The DMA controller of claim 3, wherein to pair the first channel circuit with the second channel circuit, the state machine is further operable to write a channel ID of the first channel circuit to the configuration register associated with the second channel circuit.

5. The DMA controller of claim 4, wherein the packet switch is operable to route the data from the first channel circuit to the second channel circuit via a path which couples the first channel circuit to the second channel circuit.

6. The DMA controller of claim 5, wherein the state machine is further operable to receive a second request to disable the path which couples the first channel circuit to the second channel circuit, and in response to the second request, remove the channel ID of the second channel circuit from the configuration register associated with the first channel circuit and remove the channel ID of the first channel circuit from the configuration register associated with the second channel circuit.

7. The DMA controller of claim 6, wherein the channel ID of the first channel circuit includes a thread ID of the first channel circuit and wherein the channel ID of the second channel circuit includes a thread ID of the second channel circuit.

8. The DMA controller of claim 1, wherein a latency associated with the first device is greater than a latency associated with the second devices, and wherein the state machine includes a hardware state machine.

9. A direct memory access (DMA) controller comprising:
data path circuitry including a set of primary DMA channel circuits operable to couple to a memory; and
state machine circuitry coupled to the data path circuitry;
wherein the state machine circuitry is operable to:
receive a request to transmit data via a first channel circuit of the set of primary DMA channel circuits to a device associated with a second channel circuit of a set of secondary DMA channel circuits; and
in response to the request:
pair the first channel circuit with the second channel circuit; and
instruct the data path circuitry to transmit the data from the first channel circuit to the second channel circuit.

10. The DMA controller of claim 9, wherein each of the set of primary DMA channel circuits and each of the set of secondary DMA channel circuits are associated with a configuration register.

11. The DMA controller of claim 10, wherein to pair the first channel circuit with the second channel circuit, the state machine circuitry is operable write a channel identifier (ID) of the second channel circuit to the configuration register associated with the first channel circuit.

12. The DMA controller of claim 11, wherein to pair the first channel circuit with the second channel circuit, the state machine circuitry is further operable to write a channel ID of the first channel circuit to the configuration register associated with the second channel circuit.

13. The DMA controller of claim 12, wherein to transmit the data from the first channel circuit to the second channel circuit, the data path circuitry is operable to route the data from the first channel circuit to the second channel circuit via a path of an associated packet switch which couples the first channel circuit to the second channel circuit.

14. The DMA controller of claim 13, wherein the state machine circuitry is further operable to receive a second request to disable the path which couples the first channel circuit to the second channel circuit, and in response to the second request, remove the channel ID of the second channel circuit from the configuration register associated with the first channel circuit and remove the channel ID of the first channel circuit from the configuration register associated with the second channel circuit.

15. The DMA controller of claim 14, wherein the channel ID of the first channel circuit includes a thread ID of the first channel circuit and wherein the channel ID of the second channel circuit includes a thread ID of the second channel circuit.

16. The DMA controller of claim 9, wherein a latency associated with the memory is greater than a latency associated with the device, and wherein the state machine circuitry includes a hardware state machine.

17. A non-transitory computer-readable medium having program instructions stored thereon, configured to be executable by processing circuitry, wherein the program instructions, when executed by the processing circuitry, cause the processing circuitry to at least:
cause direct memory access circuitry that includes primary DMA circuitry, secondary DMA circuitry, and a packet switch coupled between the primary DMA circuitry and the secondary DMA circuitry to transfer data between a first device coupled to the primary DMA circuitry and a second device coupled to the secondary DMA circuitry by enabling a communication path of the packet switch between the primary DMA circuitry and the secondary DMA circuitry.

18. The non-transitory computer-readable medium of claim 17, wherein the primary DMA circuitry includes a set of primary DMA channel circuits, wherein the secondary DMA circuitry includes a set of secondary DMA channel circuits, and wherein the communication path connects a first channel circuit of the set of primary DMA channel circuits to a second channel circuit of the set of secondary DMA channel circuits.

19. The non-transitory computer-readable medium of claim 18, wherein to enable the communication path, the program instructions cause the processing circuitry to cause the DMA circuitry to:
write a channel identifier (ID) of the second channel circuit to a configuration register associated with the first channel circuit; and
write a channel ID of the first channel circuit to a configuration register associated with the second channel circuit.

20. The non-transitory computer-readable medium of claim 19, wherein the program instructions further cause the processing circuitry to cause the DMA circuitry to disable the communication path, and wherein to disable the communication path, the program instructions cause the processing circuitry to cause the DMA circuitry to:
remove the channel ID of the second channel circuit from the configuration register associated with the first channel circuit; and
remove the channel ID of the first channel circuit from the configuration register associated with the second channel circuit.
